(19) United States
(12) Patent Application Publication
(10) Pub. No.: US 2025/0323491 A1
(43) Pub. Date: Oct. 16, 2025

(54) METHOD OF CONTROLLING AN ELECTRICAL PROTECTION DEVICE, ELECTRICAL PROTECTION DEVICE AND ASSOCIATED ELECTRICAL INSTALLATION

(71) Applicant: Schneider Electric Industries SAS, Rueil-Malmaison (FR)

(72) Inventors: Sébastien Heraud, Grenoble (FR); Bruno Reymond, Moirans (FR)

(73) Assignee: Schneider Electric Industries SAS, Rueil-Malmaison (FR)

(21) Appl. No.: 19/172,753

(22) Filed: Apr. 8, 2025

(30) Foreign Application Priority Data
Apr. 10, 2024 (FR) 2403702

(51) Int. Cl. H02H 3/08; H02H 1/00; H02H 3/20

(52) U.S. Cl. CPC H02H 3/08; H02H 1/0007; H02H 3/20

(57) ABSTRACT

The present invention relates to a method for controlling an electrical protection device, the device comprising an interruption cell, comprising at least one switching module, comprising a voltage limiting element having a limiting voltage,
the method comprising:
a) measuring (S102) the intensity (I) of the current;
b) detecting (S104) an electrical fault;
c) when an electrical fault is detected, the intensity is less than or equal to a minimum intensity threshold (Iₘᵢₙ), and a tripping energy (E_{d}) is strictly less than an energy threshold (Eₜₕ), controlling (S114) the switching module(s) to enter an on-configuration;
d) when an electrical fault of the short-circuit type is detected, the intensity (I) has reached a maximum intensity threshold (Iₘₐₓ) and the tripping energy (E_{d}) is strictly less than the energy threshold, controlling (S116) the switching module(s) to enter an off-configuration.

### FIELD

This invention relates to a method for controlling an electrical protection device, an electrical protection device, and an electrical installation therefor.

### BACKGROUND

In order to protect a load included in an electrical installation against electrical faults of the short-circuit type, it is known to install an electromechanical circuit breaker upstream of the load, so that the electromechanical circuit breaker and the load are connected to each other, and to install an additional electrical protection device upstream of the electromechanical circuit breaker. The electromechanical circuit breaker comprises contacts and a trip unit which, when supplied with sufficient energy, is responsible for separating the contacts. It is therefore necessary to wait until the trip unit has received sufficient energy before the protection device interrupts the current and isolates the fault by separating the contacts. This generates an increase in the current circulating in the installation, due to the presence of the short-circuit, which imposes major stresses on the installation, in particular on the loads, and on the protection device, which must be capable of withstanding such a current. A known solution is to trip the protection device when a current threshold is reached, in order to limit the stresses in the installation caused by the current, without guaranteeing that the electromechanical circuit breaker receives sufficient energy to be tripped.

### SUMMARY

The aim of the invention is therefore to propose a method of controlling an electrical protection device which ensures that an electromechanical circuit breaker trips, while limiting the stresses in the installation caused by the current in the presence of a short-circuit.

To this end, according to a first aspect, the invention relates to a method for controlling an electrical protection device, configured to be connected between a source and an electromechanical circuit breaker, the device comprising:
an interruption cell, comprising at least one switching module, each switching module comprising:
   at least one semiconductor element; and
   a voltage-limiting element, connected in parallel with the at least one semiconductor element, the voltage-limiting element having a limiting voltage, the limiting voltage or voltages, alone and/or summed together, forming one or a plurality of distinct steps,
each switching module being configured to switch between a on-configuration, wherein a current flowing between the source and the electromechanical circuit breaker flows through the or in one of the semiconductor elements, and a off-configuration, wherein if the current flows through the switching module, it flows through the limiting element;
a current sensor, configured to measure a current intensity;
a control unit comprising a processing module, and a cell control module, configured to control each switching module in the on-configuration and in the off-configuration,
the method comprising at least the following steps:
a) measuring the intensity of the current, by the current sensor;
b) detecting an electrical fault of the short-circuit type, by the processing module, as a function of the intensity measured by the current sensor;

According to the invention, the method further comprises the following successive steps:
c) when an electrical fault of the short-circuit type is detected by the processing module in step b), when the intensity measured by the sensor is less than or equal to a minimum intensity threshold and a tripping energy received by the electromechanical circuit breaker is strictly less than an energy threshold, the tripping energy being calculated by the processing module as a function of the intensity measured by the current sensor, controlling the switching module(s) whose limiting voltages of the limiting elements form the clipping level to enter the on-configuration, by means of the cell control module;
d) when an electrical fault of the short-circuit type is detected by the processing module in step b), when the current measured by the sensor reaches a maximum intensity threshold and the tripping energy calculated by the processing module is strictly less than the energy threshold, controlling the switching module(s) whose limiting voltages of the limiting elements form the clipping level to enter the off-configuration, by means of the cell control module; and
e) when the tripping energy is greater than or equal to the energy threshold, the cell control module controls each switching module into the off-configuration, regardless of the intensity (I) measured by the sensor (52).

Thanks to the invention, as long as the electromechanical circuit breaker has not received sufficient energy to trip, the device allows the current to flow. The intensity of the current is limited, however, thanks to the switching modules, which are controlled in a off-configuration when the intensity reaches a maximum intensity threshold, thus avoiding excessively high currents and risks of damage to the electromechanical circuit-breaker, the protection device and the load. In addition, by controlling the switching modules in the on-configuration when the current is less than or equal to the minimum intensity threshold, the device ensures that sufficient current flows through the electromechanical circuit breaker, ensuring that the latter receives sufficient energy to trip. Keeping the intensity between the minimum intensity threshold and the maximum intensity threshold also ensures that the electromechanical circuit breaker receives energy continuously, without discharging, and therefore ensures the fastest possible tripping. This limits the stresses caused by the intensity of the current, while ensuring that the electromechanical circuit-breaker trips quickly.

In other beneficial aspects of the invention, the method comprises one or more of the following features, taken in isolation or in any technically possible combination:

The method further comprises the following successive steps:
f) controlling each switching module to enter the on-configuration, when the tripping energy is greater than or equal to the energy threshold and each switching module has been controlled to enter the off-configuration in step e); and
g) each switching module having been controlled to enter the on-configuration in step f), if a short-circuit is detected while a duration counted from a moment when each switching module is controlled to enter the on-configuration in step g) is less than a test duration, controlling each switching module to enter the off-configuration.

The method further comprises the following step:
h) when an electrical fault of the short-circuit type is detected by the processing module in step b), controlling a mechanical switch, connected in parallel with the interruption cell, to enter an open configuration, the mechanical switch being configured to switch between a closed configuration, wherein the mechanical switch conducts the current, and the open configuration, wherein the mechanical switch does not conduct the current, by a mechanical switch control module included in the control unit.

The method further comprises the following step:
i) controlling the mechanical switch to enter the closed configuration if, when the duration of step g) is greater than or equal to the test duration, no short-circuit has been detected.

The device comprises a plurality of switching modules, connected to each other, step d) further comprising the controlling of the switching modules whose limiting voltages of the limiting elements do not form the clipping step to enter the on-configuration, by means of the cell control module.

According to a second aspect, the invention further relates to an electrical protection device, configured to be connected between a source and an electromechanical circuit breaker, the device comprising:
an interruption cell, comprising at least one switching module, each switching module comprising:
   at least one semiconductor element; and
   a voltage-limiting element, connected in parallel with the at least one semiconductor element, the voltage-limiting element having a limiting voltage, the limiting voltage or voltages, alone and/or summed together, forming one or a plurality of distinct steps,
each switching module being configured to switch between a on-configuration, wherein a current flowing between the source and the electromechanical circuit breaker flows in the or in one of the semiconductor elements, and a off-configuration, wherein if the current flows in the switching module, it flows within the limiting element;
a current sensor, configured to measure a current intensity;
a control unit comprising:
   a processing module configured to detect an electrical fault of the short circuit type as a function of the intensity measured by the current sensor and to calculate a tripping energy received by the electromechanical circuit breaker, as a function of the intensity measured by the current sensor; and
   a cell control module, configured to control each switching module in the on-configuration and in the off-configuration, the device being configured to implement the method described above.

In other beneficial aspects of the invention, the device comprises one or more of the following features, taken in isolation or in any technically possible combination:

Each switching module comprises two semiconductor elements that conduct current in only one direction and are connected in series with opposite orientations, and for each semiconductor element, a diode is connected in parallel with opposite orientations to the semiconductor element.

The interruption cell comprises two rectifying branches, the input and output of the interruption cell respectively forming a midpoint of one of the rectifying branches, each rectifying branch comprising two diodes arranged on either side of the midpoint, connected to one another in series with opposite orientations;
the switching modules are connected in parallel with the rectifying branches; and
each switching module comprises a single semiconductor element connected in parallel with the voltage limiting element.

The device comprises a single switching module, the limiting voltage of the voltage limiting element of the switching module then forming the clipping level.

According to a third aspect, the invention further relates to an electrical installation comprising a source, a load, an electromechanical circuit breaker connected between the source and the load, the electromechanical circuit breaker being configured to trip when it receives a tripping energy greater than or equal to an energy threshold, and a device as described above, connected between the source and the electromechanical circuit breaker.

### BRIEF DESCRIPTION OF THE DRAWINGS

The invention will appear more clearly when reading the description that follows, given solely as a non-limiting example and made in reference to drawings in which:

FIG. 1 is an electrical schematic of an electrical installation according to a first embodiment of the invention;

FIG. 2 is a plot of characteristic variables of the installation shown in FIG. 1, as a function of time;

FIG. 3 is a flowchart of a method for controlling a protection device belonging to the installation shown in FIG. 1;

FIG. 4 is an electrical schematic of an electrical installation according to a second embodiment of the invention;

FIG. 5 is an electrical schematic of an interruption cell of the installation of FIG. 4;

FIG. 6 is a plot of characteristic variables of the installation shown in FIGS. 4 and 5, as a function;

FIG. 7 is a flowchart of a method for controlling a protection device belonging to the installation shown in FIGS. 4 and 5; and

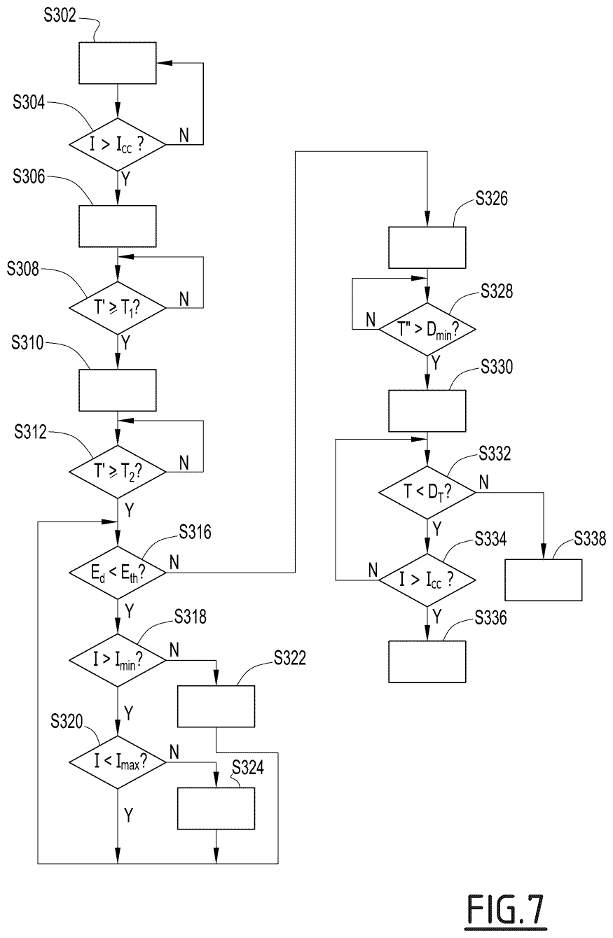

FIG. 8 is an electrical schematic of an interruption cell belonging to an installation according to a third embodiment of the invention.

### DETAILED DESCRIPTION

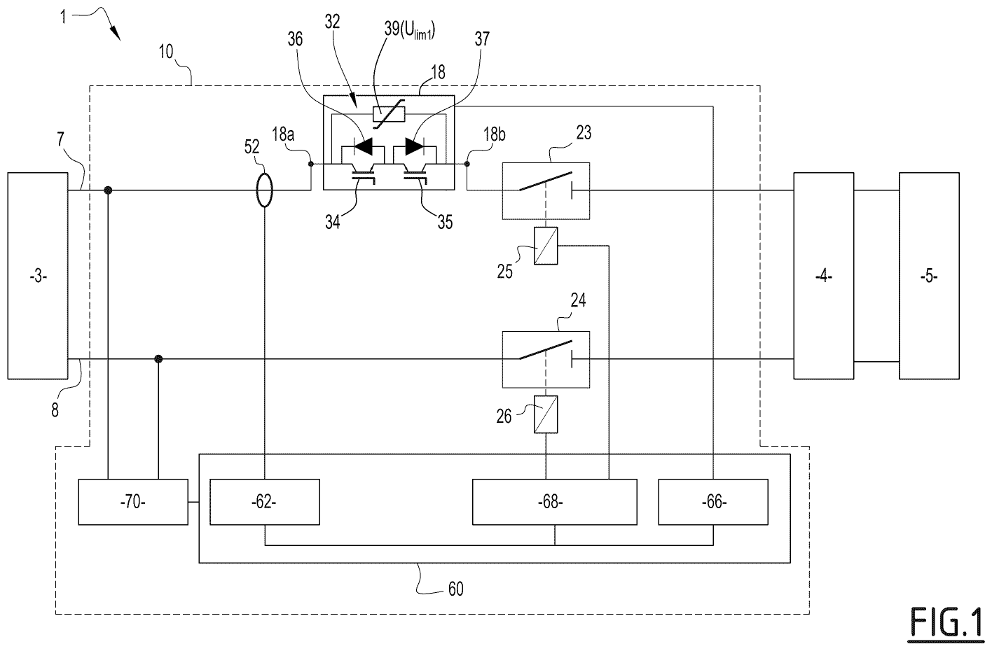

FIG. 1 is a diagram of an electrical installation 1 comprising a source 3, an electromechanical circuit breaker 4 and a load 5, electrically interconnected by a phase conductor 7 and a neutral conductor 8. The source 3 supplies electricity and is, for example, an electrical generator or an electrical network, for example a mains electrical network.

The load 5 is a device that consumes electricity, such as a domestic electrical appliance, industrial equipment such as an electric motor, or a server. In this way, an electric current, referred to hereafter simply as current, flows between the source 3 and the load 5 through the phase conductor 7, and returns to the source 3 through the neutral conductor 8.

The electromechanical circuit breaker 4 is connected between the source and the load 5. The electromechanical circuit breaker 4 comprises contacts and a trip device which may be a coil, a magnetic armature, or an electronic or electromechanical device (not shown). it is configured to interrupt the current flowing from the source 3 to the load 5 when an electrical fault of the short circuit type is present in the electrical installation 1.

The current is a low-voltage or medium-voltage current, i.e. the nominal voltage Uₛ of the current, also known as the mains voltage or nominal network voltage, is less than 52,000 V. The current is an alternating current or, alternatively, a direct current.

The electrical installation 1 further comprises an electrical protection device 10, hereinafter also referred to as the device, connected between the source 3 and the electromechanical circuit breaker 4. The device 10 is configured to switch between an armed configuration, wherein the device 10 conducts the current flowing between the source 3 and the electromechanical circuit breaker 4, and a tripped configuration, wherein the device 10 electrically isolates the source 3 from the electromechanical circuit breaker 4. The device 10 has a voltage U, expressed in volts (V), applied across its terminals, between the conductors 7 and 8. In the embodiment shown in FIG. 1, the device 10 is a solid state circuit breaker (SSCB). It comprises an interruption cell 18 connected in series to the phase conductor 7 via an input 18a and an output 18b.

The interruption cell 18 is configured to allow or interrupt the current flowing through it, as explained later.

The device 10 advantageously comprises a first disconnector 23 and, optionally, a second disconnector 24, connected respectively to the phase conductor 7 and the neutral conductor 8. In particular, the disconnector 23 is connected to the phase conductor 7 in series with the interruption cell 18. The disconnector 24 is connected in series with the neutral conductor 8. The disconnectors 23 and 24 are configured to switch between a closed configuration, wherein the disconnectors 23 and 24 conduct current, and an open configuration, wherein the disconnectors 23 and 24 do not conduct current. Advantageously, and as shown in FIG. 1, the device 10 comprises an actuator 25 of the first disconnector 23 and an actuator 26 of the second disconnector 24 which, when activated, interact respectively with the first disconnector 23 and the second disconnector 24 to cause them to switch to the open configuration. The actuators 25 and 26 are, for example, coils and are activated when a current flows through the turns of the coils.

The disconnectors 23 and 24 are configured to switch to the open position in particular when no current is flowing between the source 3 and the load 5; in other words, when the current has been interrupted by the interruption cell 18.

The interruption cell 18 comprises at least one switching module, in this case a switching module 32. The switching module 32 comprises at least one semiconductor element controllable in switching, for example at least one thyristor or at least one transistor, such as a field effect transistor, also known as a FET (Field Effect Transistor), an insulated gate field effect transistor, also known as a MOSFET (Metal Oxide Semiconductor Field Effect Transistor) transistor, also known as a MOSFET (Metal Oxide Semiconductor Field Effect Transistor), an insulated gate bipolar transistor, also known as an IGBT (Insulated Gate Bipolar Transistor), or a combination of these different semiconductor elements. In the embodiment shown in FIG. 1, the interrupter cell 18 comprises two semiconductor elements 34 and 35. The semiconductor elements 34 and 35 are unidirectional in current and are, for example, two IGBT type transistors. The conduction direction of transistors 34 and 35 is indicated by an arrow on each transistor 34, 35. The transistors 34 and 35 are connected to one another in series with opposite orientations, i.e. transistors 34 and 35 are connected in anti-series, so that they do not conduct current at the same time. Two diodes 36 and 37 are connected to transistors 34 and 35 respectively. The diode 36 is connected to the transistor 34 in parallel with opposite orientations, i.e. the diode 36 and transistor 34 do not conduct current at the same time: if the transistor 34 is conducting, the diode 36 is blocked and vice versa. In other words, the transistor 34 and the diode 36 are connected in parallel but with opposing orientations. The same applies to the transistor 35 and diode 37. This arrangement enables each switching module 32 and 42 to conduct alternating current uninterrupted whenever the sign of the current changes.

The switching module 32 comprises a voltage limiting element 39, also known as a limiting element. The voltage limiting element 39 is connected in parallel with an assembly formed by the transistors 34 and 35, and is for example a metal oxide varistor (MOV), a transil diode or a gas spark gap. The voltage limiting element 39 has a limiting voltage Uₗᵢₘ₁, which corresponds to a voltage across its terminals when the current flowing between the source 3 and the load 5 passes through it. The limiting voltage Uₗᵢₘ₁ is higher than the nominal mains voltage Uₛ, for example by about 1.5 times the nominal mains voltage Uₛ.

The switching module 32 is configured to switch between an on-configuration and a off-configuration. In the on-configuration, the current flows through one of the transistors 34 or 35. More specifically, when the current flowing through device 10 is alternating, the current flows through the transistor 34 and diode 37, then when the current changes direction, through the transistor 35 and diode 36.

In the off-configuration, the transistors 34 and 35 do not conduct current and, if current flows in the switching module 32, it flows through the voltage limiting element 39.

Thus, in the off-configuration, a voltage across the switching module 32 is the limiting voltage Uₗᵢₘ₁. This voltage across the switching module 32 is then also the voltage U across the device 10. In other words, a counter-voltage whose value is that of the limiting voltage Uₗᵢₘ₁ is applied across the terminals of the device 10.

The limiting voltage Uₗᵢₘ₁ forms a clipping level Pₑ, which is higher than the nominal mains voltage Uₛ.

The control device 10 further comprises a current sensor 52. The current sensor 52 is configured to measure an intensity I of the current, expressed in amperes (A), flowing between the source 3 and the load 5, and in particular the current flowing in the phase conductor 7. The current sensor 52 is, for example, a Rogowski coil.

The control device 10 comprises a control unit 60, comprising a processing module 62, connected to the current sensor 52 and configured to detect an electrical fault of the short-circuit type as a function of the intensity I, measured by the current sensor 52. In the following, the term short-circuit is used to designate an electrical fault of the short-circuit type.

The control unit 60 further comprises a cell control module 66 and, advantageously, a disconnector control module 68, connected to the processing module 62 and respectively configured to control the interruption cell 18, more precisely the switching module 32, and the disconnectors 23 and 24.

The cell control module 66, also known as the control module, is configured to control the switching module 32 in the on-configuration and in the off-configuration, as explained in more detail later, in particular by actuating the gate of the transistors 34 and 35.

The disconnector control module 68 is advantageously configured to operate the actuators 25 and 26 respectively, in order to switch the disconnectors 23 and 24 to the open configuration.

The control unit 60 is an electronic circuit designed to manipulate and/or transform data represented as electronic or physical quantities in registers of the control unit 60 and/or memories into other similar data corresponding to physical data in memories, registers or other types of display devices, transmission devices or storage devices.

As specific examples, the control unit 60 is in the form of a programmable logical component, such as a FPGA (Field Programmable Gate Array), or in the form a dedicated integrated circuit, such as an ASIC (Application-Specific Integrated Circuit).

In a variant not shown, the control unit 60 comprises an information processing unit formed for example by a memory and a processor associated with the memory. The processing module 62, the cell control module 66, and the disconnector control module 68 are each in the form of software, or a software brick, which can be executed by the processor. The memory of the control unit 60 is then able to store processing software, cell control software and disconnector control software. The processor is then able to run each of the processing software, cell control software and disconnector control software.

In a variant not shown, the processing module 62, the cell control module 66, and the disconnector control module 68 are each in the form of a programmable logical component, such as a FPGA (Field Programmable Gate Array), an integrated circuit, such as an ASIC (Application-Specific Integrated Circuit), or in the form of an analogue component.

Advantageously, the device 10 further comprises a power supply module 70, connected to the conductors 7 and 8 and to the control unit 60, in order to supply the control unit 60 with electricity. Alternatively, the power supply module 70 is connected to an external circuit, not connected to the conductors 7 and 8.

When a short-circuit is present in the electrical installation 1, an intensity I of the current flowing between the source 3 and the load 5 increases rapidly and significantly, for example by several thousand amperes per microsecond. The intensity I of the current becomes strictly greater than a minimum intensity threshold Iₘᵢₙ from which the trip device of the electromechanical circuit breaker 4 receives a tripping energy E_{d}, expressed in arbitrary units (a.u.) proportional to the time and to the square of the intensity I. When the tripping energy E_{d} is greater than or equal to an energy threshold Eₜₕ, the trip device of the electromechanical circuit breaker 4 causes the contacts of the electromechanical circuit breaker 4 to open in order to interrupt the current between the source 3 and the load 5, more precisely between the device 10 and the load 5. In other words, when the tripping energy E_{d} is greater than the energy threshold Eₜₕ, the electromechanical circuit breaker 4 trips.

The tripping energy E_{d} is determined by the processing module 62 as a function of the intensity I measured by the current sensor 52.

In order to limit stresses in the electrical installation, the intensity I of the current is limited by means of device 10, as explained below.

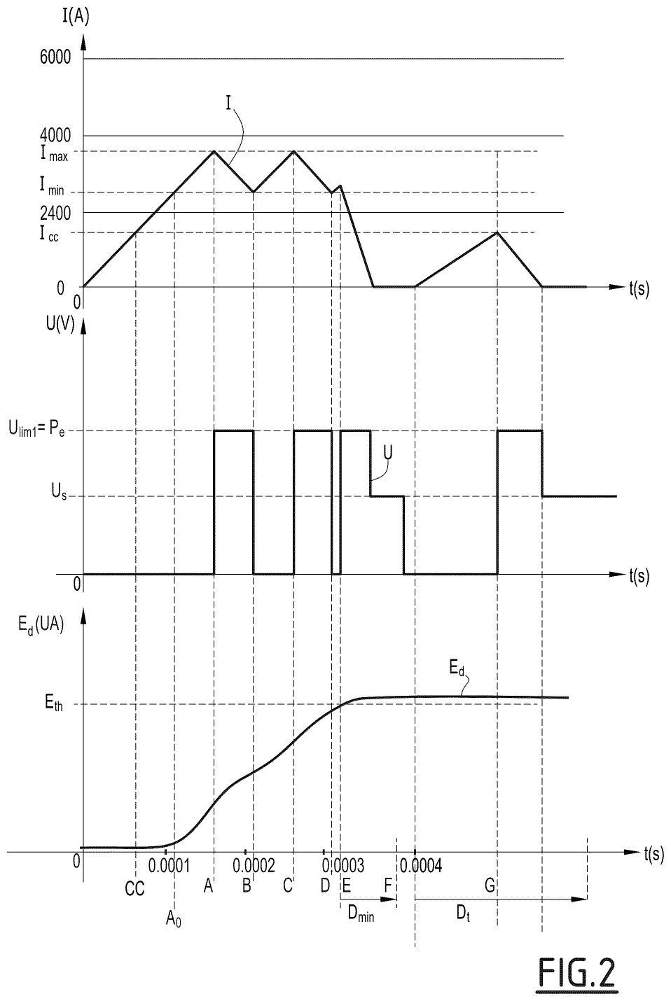

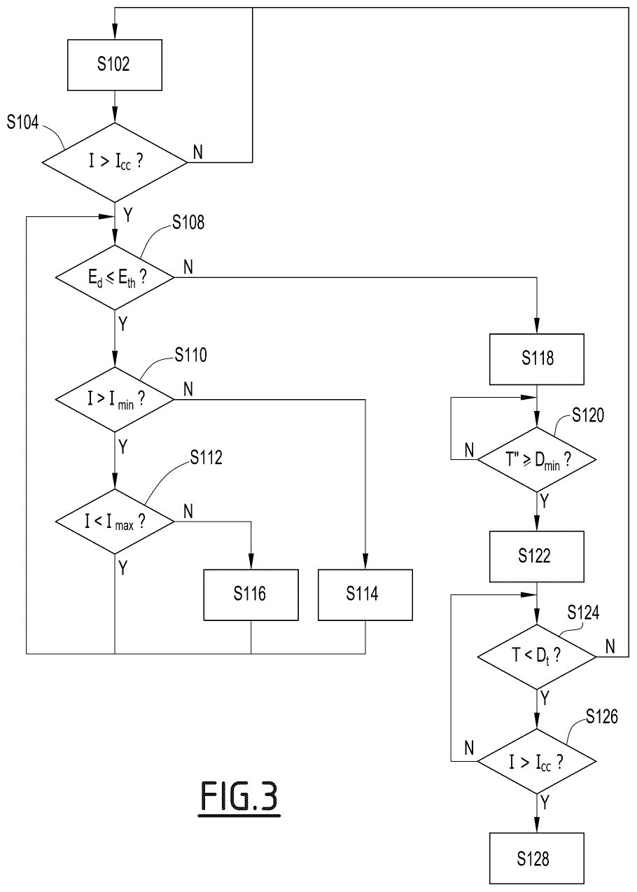

A method for controlling the device 10 in accordance with the invention will now be explained, with reference to FIGS. 2 and 3.

Advantageously, the device 10 is initially in the armed configuration, i.e. the disconnectors 23 and 24 are in the closed configuration and the switching module 32 is in the open configuration. Current flows from the source 3 to the mechanical circuit breaker 4, via the switching module 32.

The current sensor 52 measures the intensity I of the current flowing in the phase conductor 7 in step S102.

The control unit 60 receives the measurement of the intensity I of the current and detects, via the processing module 62, whether a short-circuit is present between the source 3 and the load 5, in step S104. If a short-circuit is not detected, then the current sensor 52 performs step S102 again and continues to measure the intensity I of the current. An iterative process is then implemented.

The short-circuit is detected as a function of the intensity I measured by the current sensor 52, and is detected, for example, when the intensity I is strictly greater than a predetermined threshold, in this case when the intensity is strictly greater than a fault threshold I_{cc}. Alternatively, the short-circuit is detected when a derivative of the intensity I of the current is strictly greater than a predetermined threshold, or when a combination of conditions on the intensity I of the current and its derivative are met. In the example shown in FIG. 2, a short-circuit is detected at time CC.

If a short-circuit is detected in step S104, the current is not immediately interrupted, which allows the intensity I of the current to increase in the installation 1 to give the circuit-breaker 4 time to receive the tripping energy E_{d}.

The processing module 62 starts calculating the tripping energy E_{d} received by the electromechanical circuit breaker 4 as soon as the intensity I of the current becomes strictly greater than the minimum intensity threshold Iₘᵢₙ, from which the electromechanical circuit breaker 4 receives the tripping energy E_{d}. The intensity I becomes strictly greater than the minimum intensity threshold Iₘᵢₙ from time A₀ onwards in FIG. 2.

In a variant not shown, the minimum intensity Iₘᵢₙ is less than the fault current I_{cc}. In this case, the calculation of the tripping energy E_{d} is started before the short-circuit is detected in step 104.

In a step S108, the processing module 62 compares the calculated tripping energy E_{d} with the energy threshold Eₜₕ. The energy threshold Eₜₕ is advantageously indicated by the manufacturer of the device 10, or by the installer of the device 10, who thereby indicates the energy threshold Eₜₕ corresponding to the electromechanical circuit breaker 4 downstream of the device 10.

If the tripping energy E_{d} is strictly less than the energy threshold Eₜₕ, which is the case between moments A and E in FIG. 2, the processing module 62 performs a step S110 wherein it compares the intensity I with the minimum intensity threshold Iₘᵢₙ. If the intensity I is strictly greater than the minimum intensity threshold Iₘᵢₙ, as can be seen in FIG. 2 between moments A and B, the processing module 62 compares the intensity I with the maximum intensity threshold Iₘₐₓ in step S112. If the intensity I is strictly less than the maximum intensity threshold Iₘₐₓ, the processing module 62 performs step S108 again. An iterative process is then implemented.

As can be seen in FIG. 2, at moment A, the tripping energy E_{d} is strictly below the energy threshold Eₜₕ and the intensity I has increased until it is equal to the maximum intensity threshold Iₘₐₓ. The control unit 60 controls the switching module 32 in the off-configuration via the cell control module 66 in step S116, which corresponds to moment A in FIG. 2. The voltage U across the device 10 is then equal to the clipping level Pₑ, itself equal to the limiting voltage Uₗᵢₘ₁.

The flow of current through the voltage limiting element 39 makes it possible to limit an increase in intensity I of the current caused by the short-circuit, according to the following formula:

$$TA ≅ 1 - \frac{U}{{U}_{s}}$$

where:
TA is the rate of increase in intensity I;
U is the voltage across device 10; and
Uₛ the nominal mains voltage.

In practice, the voltages induced by the resistance of conductors 7 and 8 and by the fault are considered negligible, and the rate of increase TA is therefore considered to be equal to

$$1 - \frac{U}{{U}_{s}} .$$

Since the voltage U is equal to the limiting voltage Uₗᵢₘ₁, which is higher than the nominal mains voltage Uₛ, the intensity I of the current decreases until it reaches the minimum intensity threshold Iₘᵢₙ, as shown in FIG. 2 between moments A and B.

As can be seen in FIG. 2, at moment B, the tripping energy E_{d} is strictly below the energy threshold Eₜₕ and the intensity I has decreased until it is equal to the minimum intensity threshold Iₘₐₓ. In a variant not shown, at moment B, the intensity I has decreased until it is equal to the minimum intensity threshold Iₘᵢₙ. Thus, from moment B and after step S110, a step S114 is performed, wherein the control module 66 controls the switching module 32 to enter the on-configuration. The voltage U at the terminals of device 10 drops sharply and becomes substantially zero at the same time as the intensity I increases, until it again reaches the maximum intensity threshold Iₘₐₓ, which corresponds to moment C in FIG. 2. The processing module 62 then performs steps S108, S110 and S112 again, and determines that the intensity I has reached the maximum intensity threshold Iₘₐₓ. The control module 66 then controls the switching module 32 to the off-state in step S116. The voltage U across the device 10 again becomes equal to the limiting voltage Uₗᵢₘ₁ and the intensity I decreases.

The intensity I measured by sensor 52 decreases until it is equal to the minimum intensity threshold Iₘᵢₙ, corresponding to moment D in FIG. 2. The cell control module 66 performs step S114 again and controls the switching module 32 to enter the on-state. The voltage U becomes zero again and the intensity I increases again.

In a variant not shown, at moment D, the intensity I has decreased until it has fallen strictly below the minimum intensity threshold Iₘᵢₙ.

The intensity I is maintained between the minimum intensity threshold Iₘᵢₙ and the maximum intensity threshold Iₘₐₓ as long as the tripping energy E_{d} is strictly below the energy threshold Eₜₕ. When the tripping energy E_{d} becomes greater than or equal to the energy threshold Eₜₕ, which corresponds to the moment E in FIG. 2, the electromechanical circuit breaker 4 trips. Following step S108, the processing module 62 performs step S118. In step S118, the switching module 32 is controlled by means of the cell control module 66 into the off-configuration, regardless of the intensity I measured by the sensor 52. In this way, the current is interrupted both by the electromechanical circuit breaker 4 and by the device 10. The voltage U becomes equal to the limiting voltage Uₗᵢₘ₁ and the intensity I decreases to zero. When the intensity I has become zero, the voltage U across device 10 becomes equal to the nominal mains voltage Uₛ.

Advantageously, and as shown in FIG. 2, when the tripping energy E_{d} is greater than or equal to the energy threshold Eₜₕ and the switching module 32 has been controlled to enter the off-configuration in step S118, a reconducting sequence is implemented.

The reconducting sequence comprises step S120, wherein the processing module 62 waits until a minimum duration Dₘᵢₙ, calculated from the moment when the control module 66 controls the switching module 32 to enter the off-configuration in step S118, has elapsed. To do this, in step S328, the processing module 62 compares a duration T″, measured from moment E, and the duration Dₘᵢₙ. When the duration Dₘᵢₙ has elapsed, i.e. when the duration T″ is greater than or equal to Dₘᵢₙ, the control module 66 controls the switching module 32 to enter the on-configuration in step S122, corresponding to moment F in FIG. 2. The processing module 62 compares a duration T, measured from the controlling of the switching module 32 to enter the on-configuration in step S122, with a test duration Dₜ, in a step S124. If the duration T is strictly less than the test duration Dₜ, in other words, if the test duration Dₜ has not elapsed, the processing module 62 detects whether a short-circuit is still present, in step S126. In the example shown in FIGS. 2 and 3, the processing module 62 detects a short-circuit in step S126 if the intensity I is strictly greater than a fault current loc. If the processing module 62 detects a short-circuit when the duration T is strictly below the test duration Dₜ, this means that, despite the tripping of the electromechanical circuit-breaker 4, the short-circuit has not been isolated. This may be due, for example, to the fact that the short-circuit is located between the electromechanical circuit-breaker 4 and the device 10. The cell control module 66 then controls the switching module 32 to enter the off-configuration in step S128, corresponding to moment G in FIG. 2. The voltage U across the device is then equal to the limiting voltage Uₗᵢₘ₁, until the intensity I of the current becomes zero. The voltage U then becomes equal to the nominal mains voltage Uₛ.

Advantageously, when the intensity I has become zero following step S128, the disconnector control module 68 activates the actuators 25 and 26 in order to switch the disconnectors 23 and 24 to the open configuration. The device 10 is then in the triggered configuration.

As can be seen from the above explanations, the isolators 23 and 24 only switch to the open configuration once the current has been interrupted and serve to galvanically isolate the source 3 and the load 5, but do not take part in interrupting the current as such.

If the processing module 62 does not detect a short-circuit in step S126, then the processing module 62 performs step S124 again and an iterative process is implemented. If the duration T is greater than or equal to the test duration Dₜ, in other words, if the test duration_{DT} has elapsed and no short-circuit has been detected, this means that the tripping of the electromechanical circuit-breaker 4 has isolated the short-circuit. The cell control module 66 then keeps the switching module 32 in the on-configuration and the device 10 resumes normal operation and performs step S102 again.

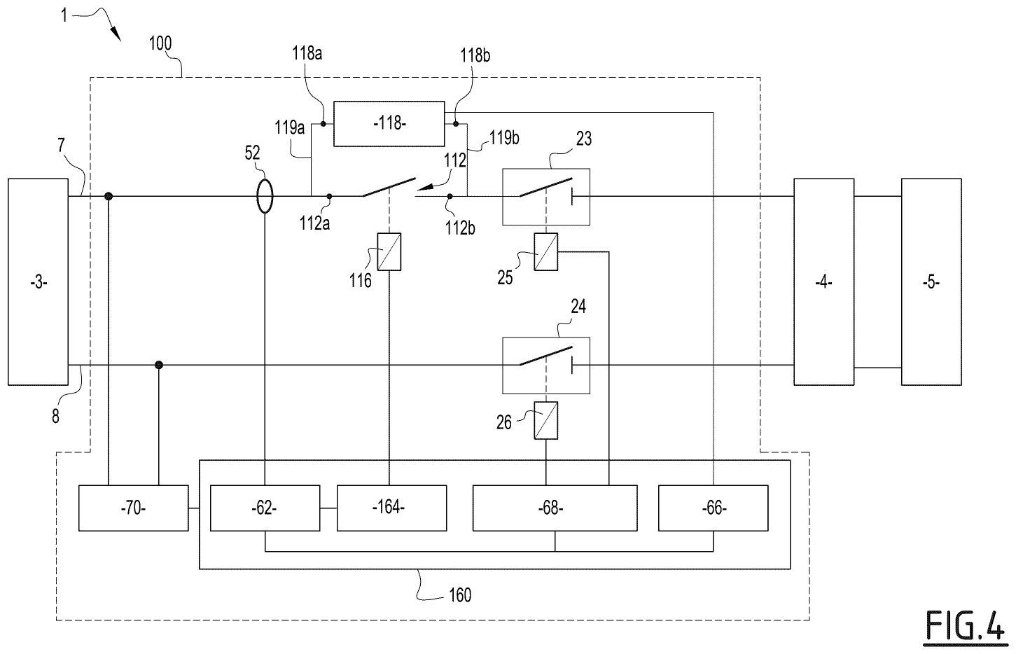

FIG. 4 shows an electrical installation 1, which differs from the electrical installation in FIG. 1 in that its device 100 replaces the device 10. The components of device 100 that are identical to those of device 10 or are identified in FIG. 4 by the same reference signs are similar, at least functionally, to those of device 10 and are not described in detail.

The device 100 is a hybrid circuit breaker, and comprises a mechanical switch 112, also known as a bypass switch, or fast mechanical switch (FMS). The mechanical switch 112 is connected in series with the phase conductor 7, via an input 112a and an output 112b, and is configured to switch between a closed configuration, wherein it conducts the current flowing between the source 3 and the load 5, and an open configuration, wherein it does not conduct the current. In FIG. 4, the mechanical switch 112 is shown in the open configuration. Advantageously, the device 100 comprises an actuator 116 which, when activated, switches the mechanical switch 112 to the open configuration.

The device 100 comprises an interruption cell 118, connected in parallel with the mechanical switch 112, such that the input 112a and output 112b of the mechanical switch 112 are connected respectively to an input 118a and an output 118b of the interruption cell 118. More specifically, the input 112a of the mechanical switch 112 and the input 118a of the interruption cell 118 are connected by an electrical link 119a, which is non-interruptible, and the output 112b of the mechanical switch 112 is connected to the output 118b of the interruption cell 118 by an electrical link 119b, which is also non-interruptible. In other words, the electrical links 119a and 119b are each an electrical cable or wire; none of the electrical links 119a and 119b comprise a switch or, more generally, a means of interrupting the electrical current. The interruption cell 118 is configured to allow or interrupt the current flowing through it, as explained later.

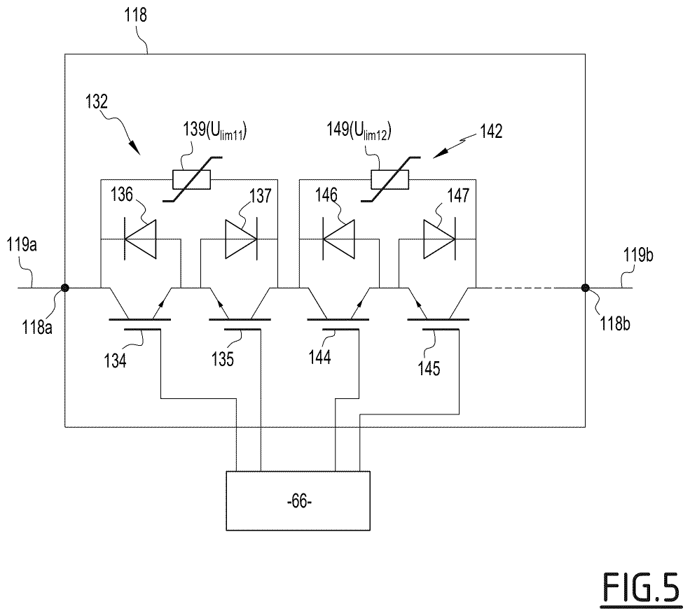

The interruption cell 118 comprises N switching modules; for example, N is equal to 2 in the example shown. The interrupter 118 comprises two switching modules 132 and 142, as shown in FIG. 5. Alternatively, there are three or more switching modules, as symbolised by the dotted line in FIG. 5.

The switching modules 132 and 142 are connected in series to one another.

In the example shown in FIG. 5, the switching module 132 is similar, at least functionally, to the switching module 32 and as such comprises two transistors 134, 135 connected in series with opposite orientations, two diodes 136 and 137 respectively connected in parallel to the transistors 134 and 135 with opposite orientations, and a limiting element 139, having a limiting voltage Uₗᵢₘ₁₁. The transistors 144, 145 and diodes 146 and 147 of the switching module 142 are respectively similar, at least functionally, to the transistors 134, 135 and diodes 136 and 137 of the switching module 132. In particular, in the example shown in FIG. 5, transistors 134, 144, 135 and 145 are unidirectional current transistors, the direction of which is indicated by an arrow on each transistor. The switching module 142 comprises a limiting element 149, connected in parallel with an assembly formed by the transistors 144 and 145 and has a limiting voltage Uₗᵢₘ₁₂, which is different from the limiting voltage Uₗᵢₘ₁₁.

The limiting voltage Uₗᵢₘ₁₁ is, for example, equal to 0.5 times Uₛ and the limiting voltage Uₗᵢₘ₁₂ is, for example, equal to 1.5 times Uₛ.

In the off-configuration, the voltages across the switching modules 132 and 142 are the limiting voltage Uₗᵢₘ₁₁ and the limiting voltage Uₗᵢₘ₁₂ respectively.

The limiting voltages Uₗᵢₘ₁₁ and Uₗᵢₘ₁₂ form at least 2^{N}-1 levels, distinct from each other. Here, the number Np of switching levels is equal to Np=^{2N}−1, where N is the number of switching modules. The levels are formed by the limiting voltages Uₗᵢₘ₁₁ and Uₗᵢₘ₁₂ taken alone, or summed together. The list of levels obtained is shown in the table below. For N=2 switching modules, three distinct levels P1, P2, P3 are obtained, with 3=2²-1. Here, P1 is the level with the lowest value, equal to Uₗᵢₘ₁₁ which is worth 0.5Uₛfor example, P2 is higher than P1, and has a value equal to Uₗᵢₘ₁₂ which is worth 1.5Uₛfor example, and P3 is higher than P2, with a value equal to the sum of Uₗᵢₘ₁₁ and Uₗᵢₘ₁₂, for example 2Uₛ.

TABLE 1

| Level | Value |
|---|---|
| P1 | Uₗᵢₘ₁₁ |
| P2 | Uₗᵢₘ₁₂ |
| P3 | Uₗᵢₘ₁₁ + Uₗᵢₘ₁₂ |

P2 is the lowest level above the nominal mains voltage, and is called the clipping level Pₑ.

The control device 100 comprises a control unit 160, which differs from the control unit 60 in that it additionally comprises a mechanical switch control module 164.

A method for operating the device 100 will now be explained, with reference to FIGS. 3 and 4.

Advantageously, the device 100 is initially in the armed configuration, i.e. the disconnectors 23 and 24 are in the closed configuration, the mechanical switch 112 is in the closed configuration, and the transistors 134, 135, 144 and 145 are conducting. Because its internal resistance is lower than that of the transistors 134, 135, 144 and 145, the mechanical switch 112 conducts all the electrical current flowing through the device 100. A voltage U across the device 100 is zero, or substantially zero.

The current sensor 52 measures the intensity I of the current flowing in the phase conductor 7 in step S302.

The control unit 160 receives the measurement of the intensity I of the current and detects, via the processing module 62, whether a short-circuit is present between the source 3 and the load 5, in step S304.

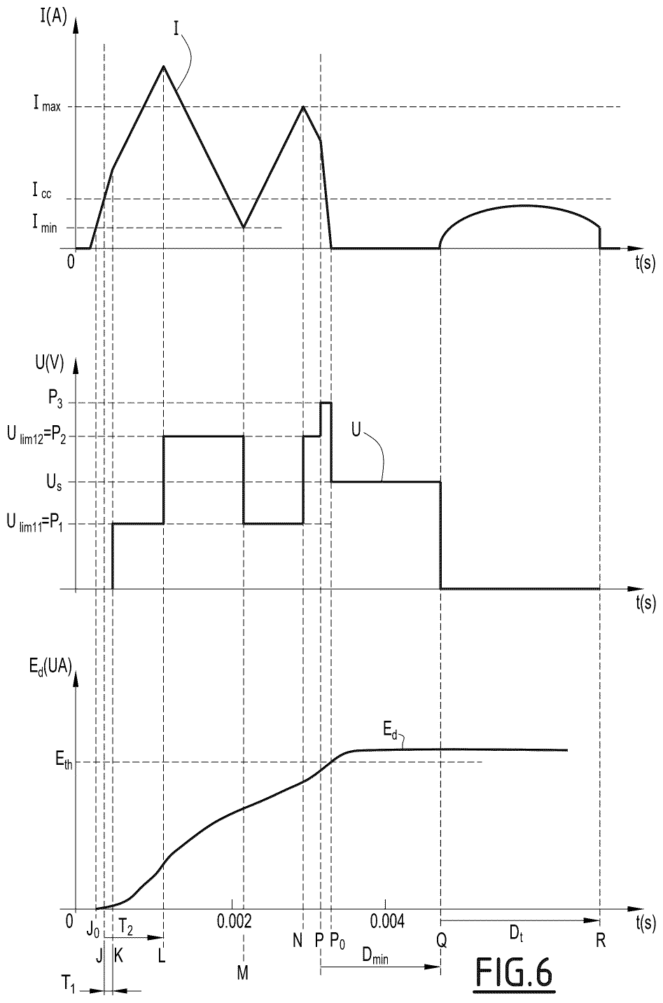

In the example shown in FIG. 6, a short-circuit is detected when the intensity I is strictly greater than the fault current I_{cc}.

If a short-circuit is not detected, then the current sensor 52 performs step S304 again and continues to measure the intensity I of the current. An iterative process is then implemented.

If a short-circuit is detected, then the control unit 160 controls the mechanical switch 112 by switching to the open configuration, via the mechanical switch control module 164, in step S306. The opening of the mechanical switch 112 corresponds to moment J in FIG. 6. In addition, if a short-circuit is detected, the processing module 62 starts a calculation of the tripping energy E_{d} received by the electromechanical circuit breaker 4. As the fault threshold I_{cc} is greater than the minimum intensity threshold Iₘᵢₙ, the trip unit of the electromechanical circuit breaker 4 receives the tripping energy E_{d}.

Alternatively, the processing module 62 starts calculating the tripping energy E_{d} as soon as the intensity I exceeds the minimum intensity threshold Iₘᵢₙ, which corresponds to moment J₀ in FIG. 6, and before the short-circuit is detected, i.e. before step S304.

When the mechanical switch 112 is in the open configuration, the electrical current is transferred from the mechanical switch 112 to the interruption cell 118. However, opening the mechanical switch 112 generates an electric arc and ionisation of the medium between the contacts of the mechanical switch 112. This reduces the dielectric strength of the mechanical switch 112. Thus, before reducing or interrupting the current flowing between the source 3 and the load 5, it is necessary to wait for sufficient dielectric strength of the mechanical switch 112 to be re-established, otherwise a restrike may occur at the terminals of the mechanical switch 112, i.e. the reappearance of an electric arc between the contacts of the mechanical switch 112, when the latter is in the open configuration, resulting in damage to the mechanical switch 112. The device 100 can then neither reduce nor interrupt the current.

The dielectric strength of the mechanical switch 112 increases over time until it exceeds one or more levels P1, P2, P3. In the example described here, P1 is the lowest level. In this way, the dielectric strength of the mechanical switch 12 becomes greater than or equal to the level P1 while being less than the levels P2 and P3. P1 is then the greatest level less than or equal to the dielectric strength of the mechanical switch 112.

Preferably, the time required between the moment when the mechanical switch 12 switches to the open configuration and the moment when the dielectric strength of the mechanical switch 12 becomes equal to the level P1 is equal to a first waiting threshold T₁.

The processing unit 62 compares a waiting duration T′ with a first waiting threshold T₁ in step S308. As long as the waiting duration T′ is less than the first waiting threshold T₁, the processing unit 62 continues to perform step S308. An iterative process is then implemented.

When the waiting duration T′ is greater than or equal to the first waiting threshold T₁, the dielectric strength of the mechanical switch 12 is equal to or greater than the level P1. Advantageously, the cell control module 166 controls the switching module 132 to enter the off-configuration at step S310, which corresponds to the moment K in FIG. 6, and the other switching modules, in this case the switching module 142, to enter the on-configuration. The transistors 134 and 135 are off and do not conduct the current, which then flows through the voltage limiting element 139 and the switching module 142. The voltage U across the device 100, and therefore across the mechanical switch 112, is then equal to the limiting voltage Uₗᵢₘ₁₁. The flow of current through the voltage limiting element 139 makes it possible to limit an increase in intensity I caused by the short-circuit, and the level P1 is also known as the limiting level. The steps S308 and S310 make it possible to limit the increase in intensity I of the current as soon as possible, by applying a voltage equal to the step P1, as soon as the dielectric strength of the mechanical switch 112 allows.

The dielectric strength of the mechanical switch 112 continues to increase and becomes equal to and then greater than the P2 level. Preferably, the time between the moment when the mechanical switch 12 switches to the open configuration and the moment when the dielectric strength of the mechanical switch 12 becomes equal to the level P2 is equal to a second waiting threshold T₂.

The processing unit 62 compares the waiting duration T′ to the second waiting threshold T₂ in step S312. As long as the waiting duration T′ is less than the second waiting threshold T₂, the processing unit 62 continues to perform step S312. An iterative process is then implemented.

When the waiting duration T′ is greater than or equal to the second waiting threshold T₂, which is the case at time L, then in a step S316, the processing module 62 compares the calculated tripping energy E_{d} with the energy threshold Eₜₕ.

If the tripping energy E_{d} is strictly less than the energy threshold Eₜₕ, the processing module 62 performs a step S318 wherein it compares the intensity I with the minimum intensity threshold Iₘᵢₙ. If the intensity I is strictly greater than the minimum intensity threshold Iₘᵢₙ, the processing module 62 compares the intensity I with the maximum intensity threshold Iₘₐₓ in step S320. If the intensity I is strictly less than the maximum intensity threshold Iₘₐₓ, the processing module 62 performs step S316 again. At the moment L, the tripping energy E_{d} is strictly less than the energy threshold Eₜₕ and the intensity I is greater than the maximum intensity threshold Iₘₐₓ. The control module 66 then controls the switching module 142 to enter the off-configuration and the switching module 132 to enter the on-configuration in step S324. In other words, the cell control module 66 controls the switching module 142 whose limiting voltage Uₗᵢₘ₁₂ of the limiting element 149 forms the clipping level Pₑ, and controls the switching modules whose limiting voltages do not form the clipping level Pₑ to enter the on-configuration. The transistors 146 and 147 are off and do not conduct the current, which then flows through the voltage limiting element 149 and the switching module 132. The voltage U at the terminals of the device 100, and therefore at the terminals of the mechanical switch 112, is then equal to level P2, equal to the limiting voltage Uₗᵢₘ₁₂, in other words, to the clipping level Pₑ. The processing module 62 performs step S316 again and an iterative process is implemented.

If the tripping energy E_{d} is strictly less than the energy threshold Eₜₕ, which is the case between moments L and P in FIG. 6, the processing module 62 performs step S110 wherein it compares the intensity I with the minimum intensity threshold Iₘᵢₙ. If the intensity I is strictly greater than the minimum intensity threshold Iₘᵢₙ, which is the case between instants L and M in FIG. 6, the processing module 62 compares the intensity I with the maximum intensity threshold Iₘₐₓ in step S320. If the intensity I is strictly less than the maximum intensity threshold Iₘₐₓ, the processing module 62 performs step S316 again. An iterative process is then implemented. Steps S316, S318 and S320 are respectively similar to steps S108, S110 and S112 of the first embodiment.

As can be seen in FIG. 6, at moment M, the tripping energy E_{d} is strictly below the energy threshold Eₜₕ and the intensity I has decreased until it is equal to the minimum intensity threshold Iₘₐₓ. Thus, following step S318, a step S322 is performed, wherein the control module 66 controls the switching module 142 to enter the on-configuration and, advantageously, the switching module 132 to enter the off-configuration. The voltage U at the terminals of device 10 becomes equal to level P1, in other words the limiting level, and the intensity I increases until it reaches the maximum intensity threshold Iₘₐₓ, corresponding to the moment N in FIG. 6.

The processing module 62 then performs steps S316, S318 and S320, and determines that the intensity I is greater than or equal to the maximum intensity threshold Iₘₐₓ. The control module 66 then controls the switching module 142 to enter the off-configuration and the switching module 132 to enter the on-configuration in step S324. In other words, in the off-configuration the control module 66 controls the switching module 142 whose limiting voltage Uₗᵢₘ₂₁ of the limiting element 149 forms the clipping level Pₑ, and in the on-configuration it controls the switching module 132 whose limiting voltage Uₗᵢₘ₁₁ of the limiting element 139 does not form the clipping level Pₑ. The voltage U at the terminals of device 10 once again becomes equal to the limiting voltage Uₗᵢₘ₁₂, in other words, the clipping level Pₑ, and the intensity I decreases.

The intensity I is maintained between the minimum intensity threshold Iₘᵢₙ and the maximum intensity threshold Iₘₐₓ as long as the tripping energy E_{d} is strictly below the energy threshold Eₜₕ. In this way, controlling the switching module 132 to enter the off-configuration in step S322 limits the increase in intensity I and limits the number of times the switching modules 132 and 142 are controlled.

When the tripping energy E_{d} becomes greater than or equal to the energy threshold Eₜₕ, which corresponds to the moment P in FIG. 6, the electromechanical circuit breaker 4 trips. Following step S316, the processing module 62 performs step S326. In step S326, the dielectric strength of the mechanical switch 112 is greater than step P3, and each switching module 132, 142 is controlled by the cell control module 66 to enter the off-configuration, regardless of the intensity I.

In this way, the current is interrupted both by the electromechanical circuit breaker 4 and by the device 10. The voltage U becomes equal in step P3 and the intensity I of the current decreases until it becomes zero, at a moment P₀ which follows the moment P, the voltage U across the device 10 becomes equal to the nominal mains voltage Uₛ.

In the example shown in FIGS. 4 to 6, controlling each switching module 132, 142 in step S326 speeds up the decrease in intensity I, compared with a variant in which only the switching modules whose limiting voltages form the clipping level Pₑ, in this case the switching module 142, are used.

Advantageously, and as shown in FIG. 6, following the control of all the switching modules in the off-configuration in step S326, a reconducting sequence is implemented, similar to the reconducting sequence described for the device 10.

The reconducting sequence comprises step S328, wherein the processing module 62 waits until the minimum duration Dₘᵢₙ, calculated from the control of the switching modules 132 and 142 in off-configuration, which takes place in step S326, has elapsed. To do this, in step S328, the processing module 62 compares a duration T″, measured from moment E, and the duration Dₘᵢₙ. When the duration Dₘᵢₙ has elapsed, i.e. when the duration T″ is greater than or equal to Dₘᵢₙ, the cell control module 66 controls all the switching modules 132, 142 to enter the on-configuration in step S330, corresponding to moment Q in FIG. 2. In a step S332, the processing module 62 determines whether the test duration Dₜ has elapsed. To do this, in step S332, the processing module 62 compares the duration T, measured from the control of the switching modules 132 and 142 to enter the on-configuration at moment Q, with the test duration Dₜ. If the duration T is strictly less than the test duration Dₜ, in other words, if the test duration Dₜ has not elapsed, the processing module 62 detects whether a short-circuit is still present, in step S334, comparing the intensity to the fault intensity I_{cc}. If the processing module 62 determines that the intensity I is strictly greater than the fault intensity I_{cc} while the test duration Dₜ has not elapsed, this means that, despite the tripping of the electromechanical circuit breaker 4, the short-circuit has not been isolated. The cell control module 66 then controls the switching module 32 to enter the off-configuration in step S336. The voltage U across the device is then equal to the level P3, until the intensity I becomes zero. The voltage U then becomes equal to the nominal mains voltage Uₛ.

Advantageously, when the intensity I has become zero following step S336, the disconnector control module 68 activates the actuators 25 and 26 in order to switch the disconnectors 23 and 24 to the open configuration. The device 10 is then in the triggered configuration.

If the processing module 62 does not detect a short-circuit in step S334, then the processing module 62 performs step S332 again and an iterative process is implemented. If the duration T is greater than or equal to the test duration Dₜ, in other words, if the test duration_{DT} has elapsed and no short-circuit has been detected, this means that the tripping of the electromechanical circuit-breaker 4 has isolated the short-circuit. This is shown in FIG. 6, between moments Q and R, between which the intensity I remains below the fault threshold I_{cc}. The cell control module 66 then keeps the switch modules 132 and 142 in the on-configuration and the mechanical switch control module 164 controls the mechanical switch 112 to enter the closed configuration in step S338. The device 10 then resumes normal operation and performs step S302 again.

In a particularly advantageous manner, when the processing module 62 calculates the tripping energy E_{d}, if the intensity I becomes substantially less than the minimum intensity Iₘᵢₙ, for example equal to 90% of the minimum intensity threshold Iₘᵢₙ before the switching modules 132 and 142 are controlled to enter the off-configuration in step S326, then the processing module 62 cancels the calculation of the tripping energy E_{d}, or decreases the tripping energy E_{d}.

Alternatively, not shown, the source 3 and the load 5 are connected together by a plurality of phase conductors, for example three. In this case, the device 10 advantageously comprises, for each phase conductor, a mechanical switch and an interruption cell connected in parallel with the mechanical switch.

Alternatively, not shown, the interruption cell 118 comprises a single switching module, for example the switching module 132. The method for controlling the device 100 is then similar to the method for controlling the device 10, with the following differences. Initially, when the device 100 is in the armed configuration, the mechanical switch 112 is in the closed configuration. The mechanical switch control module 164 controls the mechanical switch 112 in the open configuration as soon as a short-circuit is detected in step S104. The cell control module 66 only controls the switching module 132 in step S116 if the dielectric strength of the mechanical switch 112 is greater than or equal to the clipping level Pₑ. If the dielectric strength of the mechanical switch 112 is less than the clipping level Pₑ, the cell control module 66 waits until the dielectric strength of the mechanical switch 112 becomes greater than or equal to the clipping level Pₑ before performing step S116. If, in step S124, the test duration Dₜ has elapsed without a short-circuit having been detected, the mechanical switch control module controls the mechanical switch in the closed configuration, then the device 100 resumes normal operation and performs step S302 again.

Optionally, a mechanical switch is connected to the neutral conductor, with an interruption cell connected in parallel with the mechanical switch.

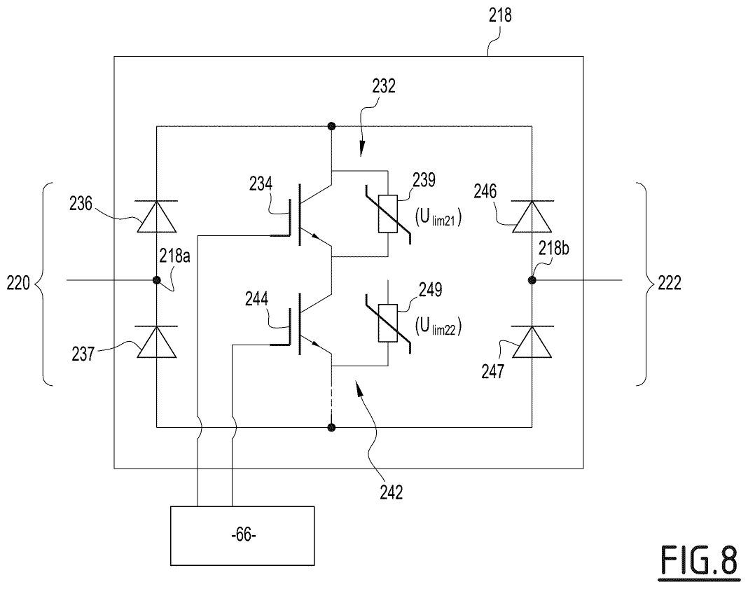

FIG. 8 is a diagram of an interruption cell 218 in accordance with a third embodiment of the invention, as an alternative to the interruption cell 18 or 118.

When the interruption cell 218 is integrated into the device 10, it replaces the interruption cell 18 and is connected in series to the phase conductor 7 via an input 218a and an output 218b.

When the interruption cell 218 is integrated into a device 100, the interruption cell 218 replaces the interruption cell 118. In this case, the interruption cell 218 is, in a similar way to the interruption cell 118, connected in parallel with the mechanical switch 112, such that the input 112a and the output 112b of the mechanical switch 112 are connected respectively to the input 218a and the output 218b of the interruption cell 218. More specifically, the input 112a of the mechanical switch 112 and the input 218a of the interruption cell 218 are connected by the electrical link 119a, which is non-interruptible, and the output 112b of the mechanical switch 112 is connected to the output 118b of the interruption cell 218 by the electrical link 119b, which is also non-interruptible.

The interruption cell 218 comprises two rectifying branches 220 and 222. Each rectifying branch 220 and 222 comprises two diodes, 236 and 237 respectively for the rectifying branch 220, and 246 and 247 for the rectifying branch 222. The diodes 236 and 237 are connected to each other in series with opposite orientations, i.e. the diodes 236 and 237 are connected in series and never conduct current at the same time. The same applies to the diodes 246 and 247.

The input 218a and output 218b of the interruption cell 218 correspond respectively to the midpoint of the rectifying branch 220, between the diodes 236 and 237, and to the midpoint of the rectifying branch 222, between the diodes 246 and 247. In this way, the interruption cell 218 is connected in parallel with the mechanical switch 112 via the midpoint of each rectifying branch 220 and 222.

The interruption cell 218 comprises two interruption modules 232 and 242. The interruption modules 232 and 242 are connected in parallel with the rectifying branches 220 and 222 and in series with each other. Alternatively, the interruption cell 218 comprises more than two interruption modules, connected in series with the interruption module 242 and in parallel with the branches 220 and 222, as symbolised by the dotted line in FIG. 8.

The interruption modules 232 and 242 respectively comprise a switchable semiconductor element, in this case a transistor 234 and 244, and a voltage limiting element 239 and 249. The voltage limiting element 239 is connected in parallel with the transistor 234 and the voltage limiting element 249 is connected in parallel with the transistor 244. The voltage limiting elements 239 and 249 are similar, at least functionally, to the voltage limiting elements 139 and 149 and have a limiting voltage Uₗᵢₘ₂₁ and Uₗᵢₘ₂₂ respectively. The limiting voltage Uₗᵢₘ₂₁ is different from the limiting voltage Uₗᵢₘ₂₂ and these voltages form three steps, similar to the limiting voltages Uₗᵢₘ₁₁ and Uₗᵢₘ₁₂.

The interruption cell 218 is configured to receive alternating current and convert it to direct current using the diodes 236, 237, 246 and 247, so that direct current flows through the switching modules 232 and 242. The arrangement of diodes 236, 237, 246 and 247 limits the number of diodes in the interruption cell 218 to four. Thus, even when the interruption cell 218 comprises more than two switching modules, only the four diodes 236, 237, 246 and 247 are required for their operation, thus limiting the number of diodes required relative to the interruption cell 118.

The method for controlling the protection device 10 comprising an interruption cell 218 and the method for controlling the protection device 100 comprising an interruption cell 218 are similar to those described respectively for the protection device 10 comprising the interruption cell 18 and for the protection device 100 comprising the interruption cell 118 and are not again described in detail.

In an alternative applicable to all embodiments (not shown), the electrical installation 1 does not comprise a neutral conductor 8.

Any feature described for one embodiment or variant in the foregoing may be implemented for the other embodiments and variants described above, insofar as technically feasible.

1. A method for controlling an electrical protection device configured to be connected between a source and an electromechanical circuit breaker, the device comprising:
an interruption cell, comprising at least one switching module, each switching module comprising:
at least one semiconductor element; and
a voltage limiting element, connected in parallel with the at least one semiconductor element, the voltage limiting element having a limiting voltage, the limiting voltage or voltages, alone and/or summed together, forming one or a plurality of distinct levels,
each switching module being configured to switch between an on-configuration, wherein a current flowing between the source and the electromechanical circuit breaker flows through the or one of the semiconductor elements, and an off-configuration, wherein if the current flows through the switching module, it flows through the limiting element;
a current sensor, configured to measure a current intensity;
a control unit comprising a processing module and a cell control module, configured to control each switching module in the on-configuration and in the off-configuration,
the method comprising at least the following steps:
a) measuring the intensity of the current, by the current sensor;
b) detecting an electrical fault of the short-circuit type, by the processing module, as a function of the intensity measured by the current sensor;
wherein that the method further comprises the following successive steps:
c) when an electrical fault of the short-circuit type is detected by the processing module in step b), when the intensity measured by the sensor is less than or equal to a minimum intensity threshold and a tripping energy received by the electromechanical circuit breaker is strictly less than an energy threshold, the tripping energy being calculated by the processing module as a function of the intensity measured by the current sensor, controlling the switching module or modules whose limiting voltages of the limiting elements form a clipping level to enter the on-configuration, by means of the cell control module;
d) when an electrical fault of the short-circuit type is detected by the processing module in step b), when the current measured by the sensor reaches a maximum intensity threshold and the tripping energy calculated by the processing module is strictly less than the energy threshold, controlling the switching module(s) whose limiting voltages of the limiting elements form the clipping level to enter the off-configuration, by means of the cell control module; and
e) when the tripping energy is greater than or equal to the energy threshold, controlling each switching module into the off-configuration, by means of the cell control module, regardless of the intensity measured by the sensor.

2. The method according to claim 1, further comprising the following successive steps:
f) controlling each switching module to enter the on-configuration, while the trigger energy is greater than or equal to the energy threshold and each switching module has been controlled to enter the off-configuration in step e); and
g) each switching module having been controlled to enter the on-configuration in step f), if a short-circuit is detected while a duration counted from a moment when each switching module is controlled to enter the on-configuration in step g) is less than a test duration, controlling each switching module to enter the off-configuration.

3. The method according to claim 2, wherein the method further comprises the following step:
h) when an electrical fault of the short-circuit type is detected by the processing module in step b), controlling a mechanical switch, connected in parallel with the interruption cell, to enter an open configuration, the mechanical switch being configured to switch between a closed configuration, wherein the mechanical switch conducts the current, and the open configuration, wherein the mechanical switch does not conduct the current, by a mechanical switch control module included in the control unit.

4. The method according to claim 3, further comprising the following steps:
i) controlling the mechanical switch to enter the closed configuration if, when the duration of step g) is greater than or equal to the test duration, no short-circuit has been detected.

5. The method according to claim 1, wherein the device comprises a plurality of switching modules, connected to each other, step d) further comprising the controlling of the switching modules whose limiting voltages of the limiting elements do not form the clipping step, to enter the on-configuration, by means of the cell control module.

6. The method according to claim 1, wherein the method further comprises the following step:
h) when an electrical fault of the short-circuit type is detected by the processing module in step b), controlling a mechanical switch, connected in parallel with the interruption cell, to enter an open configuration, the mechanical switch being configured to switch between a closed configuration, wherein the mechanical switch conducts the current, and the open configuration, wherein the mechanical switch does not conduct the current, by a mechanical switch control module included in the control unit.

7. An electrical protection device configured to be connected between a source and an electromechanical circuit breaker, the device comprising:
an interruption cell, comprising at least one switching module, each switching module comprising:
at least one semiconductor element; and
a voltage limiting element, connected in parallel with the at least one semiconductor element, the voltage limiting element having a limiting voltage, the limiting voltage or voltages, alone and/or summed together, forming one or a plurality of distinct levels,
each switching module being configured to switch between an on-configuration, wherein a current flowing between the source and the electromechanical circuit breaker flows through the or one of the semiconductor elements, and an off-configuration, wherein if the current flows through the switching module, it flows through the limiting element;
a current sensor, configured to measure a current intensity;
a control unit comprising:
a processing module configured to detect an electrical fault of the short circuit type as a function of the intensity measured by the current sensor and to calculate a tripping energy received by the electromechanical circuit breaker, as a function of the intensity measured by the current sensor; and
a cell control module, configured to control each switching module to enter the on-configuration and the off-configuration,
the device being configured to implement the method of claim 1.

8. The device according to claim 7, wherein each switching module comprises two semiconductor elements which are unidirectional in current and connected to each other in series with opposite orientations, and for each semiconductor element a diode is connected in parallel with opposite orientations to the semiconductor element.

9. The device according to claim 7, wherein:
the interruption cell comprises two rectifying branches, the input and the output of the interruption cell respectively forming a midpoint of one of the rectifying branches, each rectifying branch comprising two diodes arranged on either side of the midpoint, connected in series to each other with opposite orientations;
the switching modules are connected in parallel to the rectifying branches; and
each switching module comprises a single semiconductor element connected in parallel to the voltage limiting element.

10. The device according to claim 8, comprising a single switching module, the limiting voltage of the voltage limiting element of the switching module then forming the clipping level.

11. An electrical installation comprising a source, a load, an electromechanical circuit breaker connected between the source and the load, the electromechanical circuit breaker being configured to trip when it receives a tripping energy greater than or equal to an energy threshold, and a device according to claim 8, connected between the source and the electromechanical circuit breaker.
